(19) United States
(12) Patent Application Publication
(10) Pub. No.: US 2012/0246380 A1
(43) Pub. Date: Sep. 27, 2012

(54) NEIGHBORHOOD OPERATIONS FOR PARALLEL PROCESSING

(76) Inventors: Avidan Akerib, Tel Aviv (IL); Eli Ehrman, Beit Shemesh (IL); Oren Agam, Zichron Yaakov (IL); Moshe Meyassed, Kadima (IL); Yehoshua Meir, Tel Mond (IL); Yukio Fukuzo, Hachiouji (JP)

(21) Appl. No.: 13/502,797

(22) PCT Filed: Oct. 6, 2010
(86) PCT No.: PCT/IB10/54526

§ 371 Date: Jun. 19, 2012

Related U.S. Application Data
(60) Provisional application No. 61/253,563, filed on Oct. 21, 2009.

(51) Int. Cl. G06F 12/06

(52) U.S. Cl. 711/5; 711/E12.082

(57) ABSTRACT

A memory device includes a plurality of storage units in which to store data of a bank, wherein the data has a logical order prior to storage and a physical order different than the logical order within the plurality of storage units and a within-device reordering unit to reorder the data of a bank into the logical order prior to performing on-chip processing. In another embodiment, the memory device includes an external device interface connectable to an external device communicating with the memory device, an internal processing element to process data stored on the device and multiple banks of storage. Each bank includes a plurality of storage units and each storage unit has two ports, an external port connectable to the external device interface and an internal port connected to the internal processing element.

### CROSS-REFERENCE TO RELATED APPLICATIONS

This application claims priority benefit from U.S. Provisional Patent Application No. 61/253,563, filed Oct. 21, 2010, which is hereby incorporated in its entirety by reference.

### FIELD OF THE INVENTION

The present invention relates to memory devices generally and to incorporation of data processing functions in memory devices in particular.

### BACKGROUND OF THE INVENTION

Memory arrays, which store large amounts of data, are known in the art. Over the years, manufacturers and designers have worked to make the arrays physically smaller while increasing the amount of data stored therein.

Computing devices typically have one or more memory arrays to store data and a central processing unit (CPU) and other hardware to process the data. The CPU is typically connected to the memory array via a bus. Unfortunately, while CPU speeds have increased tremendously in recent years, the bus speeds have not increased at an equal pace. Accordingly, the bus connection acts as a bottleneck to increased speed of operation.

U.S. patent application Ser. No. 12/119,197, whose disclosure is incorporated herein by reference and which is owned by the common assignees of the present application, describes a memory device which comprises RAM along with one or more special sections containing associative memory cells. These memory cells may be used to perform parallel computations at high speed. Integrating these associative sections or any other computing ability into the memory device minimizes the resources needed to transfer data into and out of the computation sections, and thus enables the device to perform logical and arithmetic operations on large vectors of bits far faster than is possible in conventional processor architectures.

The associative cells are functionally and structurally similar to CAM cells, in that comparators are built into each associative memory section so as to enable multiple multi-bit data words in the section to be compared simultaneously to a multi-bit comparand. These comparisons are used in the associative memory section as the basis for performing bit-wise operations on the data words.

As explained in the thesis by Akerib, entitled “Associative Real-Time Vision Machine” (Department of Applied Mathematics and Computer Science, Weizmann Institute of Science, Rehovot, Israel, March, 1992), these bit-wise operations serve as the building blocks for a wide range of arithmetic and logical operations, which can thus be performed in parallel over multiple words in the associative memory section.

Reference is now briefly made to FIG. 1, a figure from U.S. patent application Ser. No. 12/119,197. FIG. 1 schematically shows an exemplary memory element 50 which performs in-memory processing. In element 50, each section 26 of a memory array comprises a top array 54 and a bottom array 56 of DRAM (dynamic random access memory) cells, separated by an array of sense amplifiers 28. The top and bottom array may each comprise 256 rows of cells, for example.

Element 50, however, includes at least one computation region 58, comprising a central slice 60 in which a computation section 64 is sandwiched between the rows of sense amplifiers 62 of the top and bottom arrays. Computation section 64 comprises CAM-like associative cells and tag logic, as explained in U.S. Ser. No. 12/119,197. Data bits stored in the cells of arrays 54 and 56 in region 58 are transferred to computation section 64 via sense amplifiers 62. Computation section 64 then performs any selected parallel processing on the data of the copied row, after which the results are written back into either top array 54 or bottom array 56. This arrangement permits rapid data transfer between the storage and computation sections of region 58 in the memory device. Although FIG. 1 shows only a single computation region of this sort, there may be multiple computation regions.

### SUMMARY OF THE INVENTION

There is provided, in accordance with a preferred embodiment of the present invention, a memory device including an external device, an internal processing element and multiple banks of storage. The external device interface is connectable to an external device communicating with the memory device and the internal processing element processes data stored on the device. Each bank includes a plurality of storage units and each storage unit has two ports, an external port connectable to the external device interface and an internal port connected to the internal processing element.

Moreover, in accordance with a preferred embodiment of the present invention, the plurality of storage units are formed into an upper row of units and a lower row of units and also include a computation belt between the upper and lower rows, wherein the internal port and the processing element are located within the computation belt.

Additionally, in accordance with a preferred embodiment of the present invention, the computation belt includes an internal bus to transfer the data from the internal port to the processing element.

Further, in accordance with a preferred embodiment of the present invention, the internal bus is a reordering bus to reorder the output of the internal port to match a pre-storage logical order of the data.

Still further, in accordance with a preferred embodiment of the present invention, the reordering bus includes four lines each to provide bytes from one of the internal ports to every fourth byte storage unit of the processing element.

Additionally, in accordance with a preferred embodiment of the present invention, each line connects between one internal port and the processing element.

Further, in accordance with a preferred embodiment of the present invention, two of the lines connect between one internal port and the processing element.

Moreover, in accordance with a preferred embodiment of the present invention, the internal port includes a plurality of sense amplifiers and a buffer to store the output of the sense amplifiers.

Further, in accordance with a preferred embodiment of the present invention, the banks of storage include one of the following types of memory: DRAM memory, 3T DRAM, SRAM memory, ZRAM memory and Flash memory.

Additionally, in accordance with a preferred embodiment of the present invention, the processing element includes 3T DRAM elements.

Moreover, in accordance with a preferred embodiment of the present invention, the processing element also includes sensing circuitry to sense a Boolean function of at least two activated rows of the 3T DRAM elements.

Further, in accordance with a preferred embodiment of the present invention, the processing element includes a shift operator.

There is also provided, in accordance with a preferred embodiment of the present invention, a memory device including a plurality of storage banks and a computation belt. The plurality of storage banks store data and are formed into an upper row of units and a lower row of units. The computation belt is located between the upper and lower rows and performs on-chip processing of data from the storage units.

Moreover, in accordance with a preferred embodiment of the present invention, each bank includes a plurality of storage units and each storage unit has an internal port forming part of the computation belt.

Additionally, in accordance with a preferred embodiment of the present invention, the computation belt includes a processing element.

Further, in accordance with a preferred embodiment of the present invention, the computation belt includes an internal bus to transfer the data from the internal ports to the processing element.

There is also provided, in accordance with a preferred embodiment of the present invention, a memory device including a plurality of storage units and a within-device reordering unit. The plurality of storage units store data of a bank, wherein the data has a logical order prior to storage and a physical order different than the logical order within the plurality of storage units. The within-device reordering unit reorders the data of a bank into the logical order prior to performing on-chip processing.

Moreover, in accordance with a preferred embodiment of the present invention, the storage units are formed of DRAM memory units.

Further, in accordance with a preferred embodiment of the present invention, the reordering unit includes a plurality of sense amplifiers, each to read data of its associated storage unit and a data transfer unit to reorder the output of the sense amplifiers to match the logical order of the data.

Still further, in accordance with a preferred embodiment of the present invention, N storage units spread across the memory device form a bank to which an external device writes data and the data transfer unit operates to provide data of one bank to an on-chip processing element.

Additionally, in accordance with a preferred embodiment of the present invention, the data transfer unit includes an internal bus and at least one compute engine controller at least to indicate to the internal bus how to place data from each of the plurality of the sense amplifiers associated with storage units of one of the banks into the processing element.

Moreover, in accordance with a preferred embodiment of the present invention, the internal bus includes N lines each to transfer a unit of data between the sense amplifiers of one storage unit and every Nth data location of the processing element, wherein the lines together connect to all data locations of the processing element.

Alternatively, in accordance with a preferred embodiment of the present invention, the internal bus includes N lines each to transfer a unit of data between the sense amplifiers and every Nth data location of the processing element, wherein two of the lines transfer from one storage unit and two of the lines transfer from a second storage unit.

Moreover, in accordance with a preferred embodiment of the present invention, the at least one compute engine controller indicates to the internal bus where to begin placement or removal of the data.

Further, in accordance with a preferred embodiment of the present invention, the processing element includes a 3T DRAM array, sensing circuitry for sensing the output when multiple rows of the 3T DRAM array are generally simultaneously activated and a write unit to write the output back to the 3T DRAM array.

Still further, in accordance with a preferred embodiment of the present invention, the memory device includes a 3T DRAM array and the reordering unit writes back to the 3T DRAM array for processing.

There is still further provided, in accordance with a preferred embodiment of the present invention, a method of performing parallel processing on a memory device. The method includes, on the device, performing neighborhood operations on data stored in a plurality of storage units of a bank, even though the data has a logical order prior to storage and a physical order different than the logical order within the plurality of storage units.

Moreover, in accordance with a preferred embodiment of the present invention, the performing includes accessing data from the plurality of storage units, reordering the data into its logical order and performing neighborhood operations on the reordered data.

Finally, in accordance with a preferred embodiment of the present invention, the neighborhood operations form part of image processing operations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a prior art, in-memory processor;

FIG. 2A is a schematic illustration of a prior art logical to physical mapping of memory banks;

FIG. 2B is a schematic illustration of a prior art memory array with the physical memory banks of FIG. 2A;

FIG. 2C is a schematic illustration of the elements of one memory bank of FIG. 2B;

FIG. 3 is a schematic illustration of a memory device, constructed and operative in accordance with a preferred embodiment of the present invention;

FIGS. 4A and 4B are schematic illustrations of two alternative storage arrangements for data in the memory banks of FIG. 3;

FIGS. 5A and 5B are schematic illustrations of two alternative bus structures for bringing the data stored according to the arrangements of FIGS. 4A and 4B, respectively, into the logical order of the data;

FIG. 6 is a circuit diagram of a shift operator, useful in the memory device of FIG. 3;

FIG. 7 is a schematic illustration of a method of performing Boolean operations on data stored in a memory array; and

FIG. 8 is a schematic illustration of how to perform the operation of FIG. 7 within the memory device of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Many memory units, such as DRAMs and others, are not committed to maintaining the original, “logical” order of the data (i.e. the order by which the data is provided to the memory unit). Instead, many memory units change the logical order to a “physical” order when storing it among the multiple storage elements of the memory unit, at least in part for efficiency. The memory units reorder the data upon reading it out.

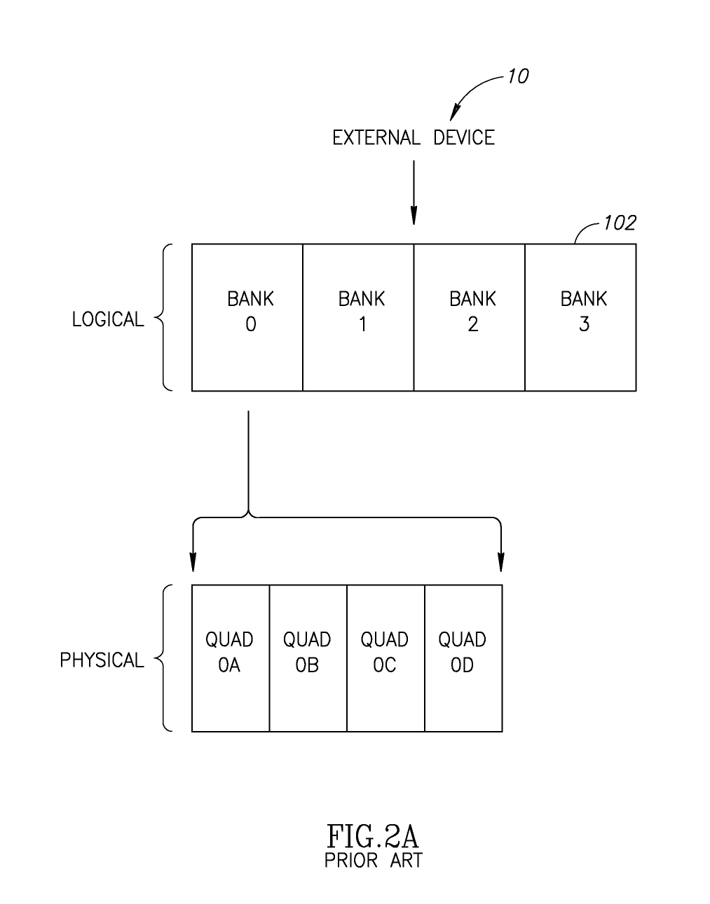

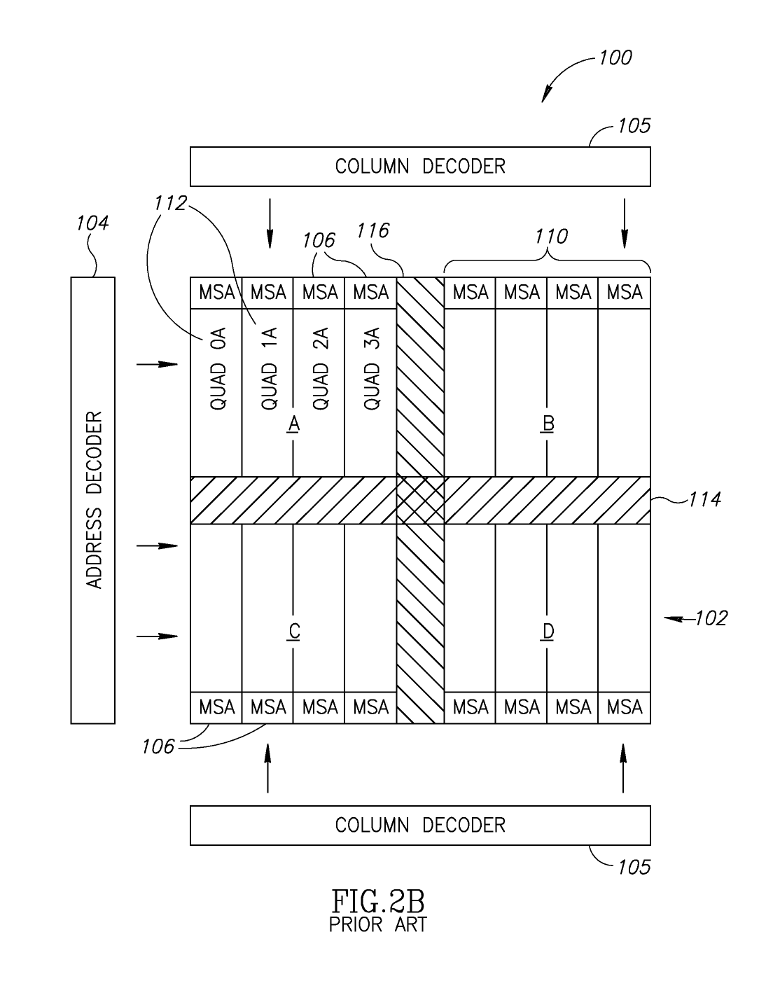

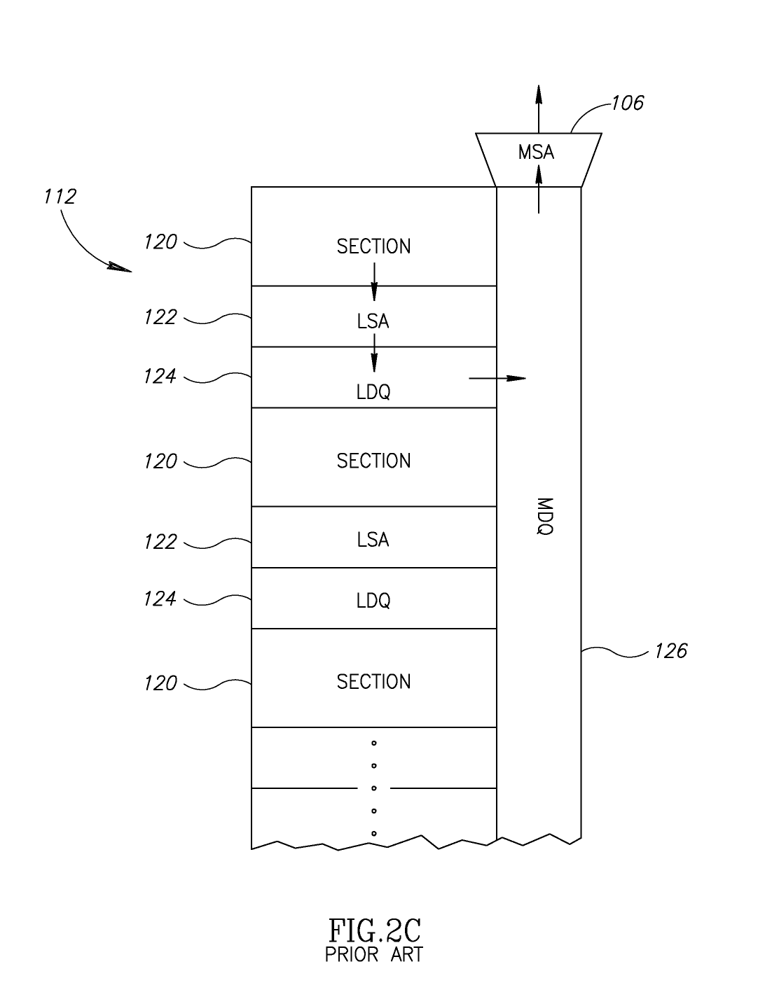

Reference is now made to FIG. 2A, which illustrates how DRAMs organize storage, and to FIGS. 2B and 2C, which illustrate a standard architecture of a DRAM 100.

As illustrated in FIG. 2A, an external device 10, or the software of external device 10, may write data to one of several “logical” banks of DRAM 100. The amount of banks may vary from one device to another; marketed devices today have 4, 8, 16 or more banks. FIG. 2A illustrates a device with 4 banks, labeled banks 0-3. However, DRAM 100 typically divides each bank into “physical” subparts, located in separate regions of a memory array 102. FIG. 2B illustrates a DRAM device with four logical banks each divided into 4 physical quads. For example, bank 0 is shown in FIG. 2A as physically divided into quad0A, quad0B, quad0C and quad0D.

As shown in FIG. 2B, DRAM 100 typically comprises a memory array 102 to store data, an address decoder 104 to activate rows of stored data and column decoders 105 to activate a set of main sense amplifiers (MSAs) 106 to read the values of the data in the activated TOWS.

Memory array 102 is shown divided into four regions 110, where each region 110 may be divided into multiple quads 112. FIG. 2A shows four quads 112 of an “A” region, labeled “quad 0A”, “quad 1A”, “quad 2A” and “quad 3A”. FIG. 2B also shows “B”, “C” and “D” regions, though in less detail. Bank 0 is thus spread across regions 110 in quads 0A, 0B, 0C and 0D.

Running along the horizontal middle of memory array 102 is a horizontal belt 114 and running along the vertical middle of memory array 102 is a spine 116. Belt 114 and spine 116 may be used to run power and control lines to the various elements of memory array 102.

FIG. 2C details one quad 112. Quad 112 may comprise 16k rows, divided into multiple sections 120 of N rows each. For example, there may be 128 sections 120 of 128 rows each. Each section may have its own local sense amplifiers (LSAs) 122 and its own local bus 124, called an “LDQ”. Each bit of a row of section 120 may have its own local sense amplifier 122. For example, there may be 8K bits in a row and thus, there may be 8K local sense amplifiers 122 for each section 120. In addition, each quad 112 may comprise a main bus 126, labeled MDQ, which typically extends the length of quad 112 and connects to each of the local busses 124 and to the quad's MSA 106.

When data is to be read from a specific row in a specific section 120, address decoder 104 (FIG. 2B) may activate the row, and column decoder 105 may activate all or a portion of the local sense amplifiers 122 to read the data of that section. Once the data has been read, it may be transferred to local bus 124. Local bus 124 may transfer a portion, such as 32 bits, of the data at a time, from local sense amplifiers 122 towards main bus 126. Main bus 126 may transfer the data from local busses 124 to an associated set of main sense amplifiers 106. Finally, data is transferred from main sense amplifiers 106 to the output pins (not shown) of DRAM 100.

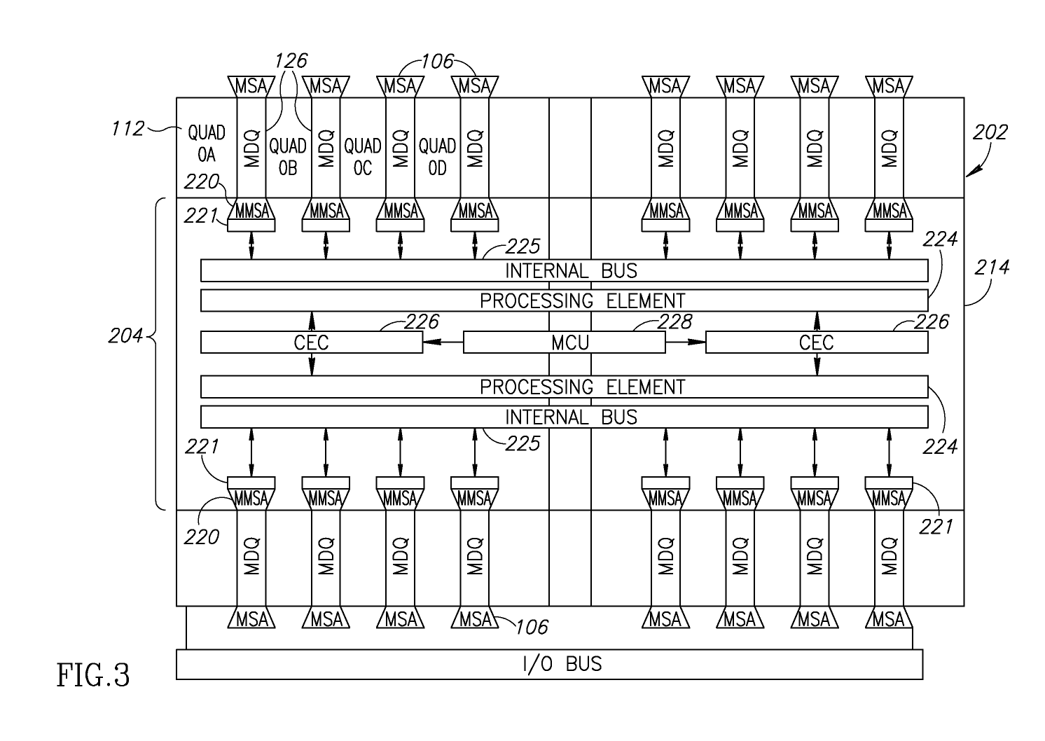

Reference is now made to FIG. 3, which illustrates a memory device 202 for a DRAM, constructed and operative in accordance with a preferred embodiment of the present invention, which may enable on-chip processing.

memory device 202 Like memory array 102 of FIG. 2A, memory device 202 may be divided into four regions 110, labeled A, B, C and D, each of which may be divided into multiple quads 112, with spine 116 dividing the regions. In accordance with a preferred embodiment of the present invention, memory device 202 may comprise a processing belt 204, formed of a plurality of mirror main sense amplifiers (MMSAs) 220 and a computation engine (CE) belt 214. CE belt 214 may comprise a processing element 224, an internal bus 225, a multiplicity of compute engine controllers (CECs) 226 and a microcontroller (MCU) 228. memory device 202

Mirror main sense amplifiers 220 may be located on the side of each quad 112 close to CE belt 214, connected to the same main bus (MDQ) 126 as main sense amplifiers 106. In effect and as shown in FIG. 3, main sense amplifiers 106 may be connected to one end of each main bus 126 and mirror main sense amplifiers 220 may be connected to the other end of each main bus 126. Mirror sense amplifiers are not necessarily fully functioning sense amplifiers as are known in the art but might be simpler circuits.

Mirror main sense amplifiers 220 may operate in the same way as main sense amplifiers 106. However, mirror main sense amplifiers 220 may connect their quads 112 to the internal processing elements of processing belt 204 via internal bus 225 while main sense amplifiers 106 may connect their quads to external processing elements, such as external device 10 (FIG. 2A) via an external interface. It will be appreciated that DRAM 200 may have dual ports—an external set of ports (main sense amplifiers 106) and an internal set of ports (mirror main sense amplifiers 220).

Mirror main sense amplifiers 220 may be controlled by similar but parallel logic to that which controls main sense amplifiers 106. They may work in lock-step with main sense amplifiers 106, such that data may be copied to both main sense amplifiers 106 and mirror main sense amplifiers 220 at similar times, or they may work independently.

There may be the same number of mirror main sense amplifiers 220 per quad as main sense amplifiers 106 or a simple multiple of the number of main sense amplifiers 106. Thus, if there are 32 main sense amplifiers 106 per quad 112, there may be 32, 64 or 128 mirror main sense amplifiers 220 per quad 112.

Unlike main sense amplifiers 106, which may all be connected to an output bus (not shown), each set of mirror main sense amplifiers 220 per quad 112 may be connected to an associated buffer 221, which may hold the data until processing element 224 may require it. Thus, mirror main sense amplifiers 220 may enable accessing all quads in all banks, in parallel, if desired. Such is not possible with main sense amplifiers 106 which all provide their output directly to the same output bus and, accordingly, it is not possible for them to work at the same time. Moreover, buffers 221 may enable memory device 202 to have a similar timing to that of a memory array in a standard DRAM.

Mirror main sense amplifiers 220 may be connected to processing element 224 via internal bus 225, which may be a standard bus or an internal bus, as described in more detail hereinbelow. Internal bus 225 may be M bits wide, where M may be a function of the number of mirror main sense amplifiers 220 per quad 112. For example, M may be 64 or 128.

Processing element 224 may be any suitable processing or comparison element. For example, processing element 224 may be a massively parallel processing element, such as Processing elementary of the processing elements described in US patent publications 2009/0254694, 2009/0254697 and in U.S. patent application Ser. Nos. 12/503,916 and 12/464,937, all owned by the common assignee of the present invention and all incorporated herein by reference.

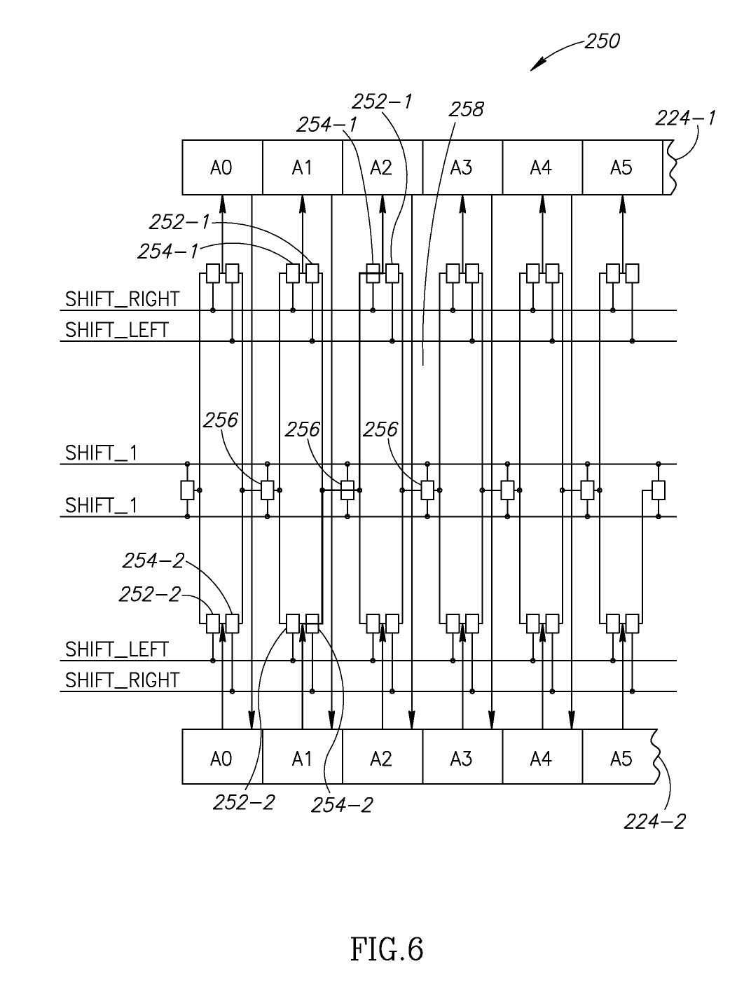

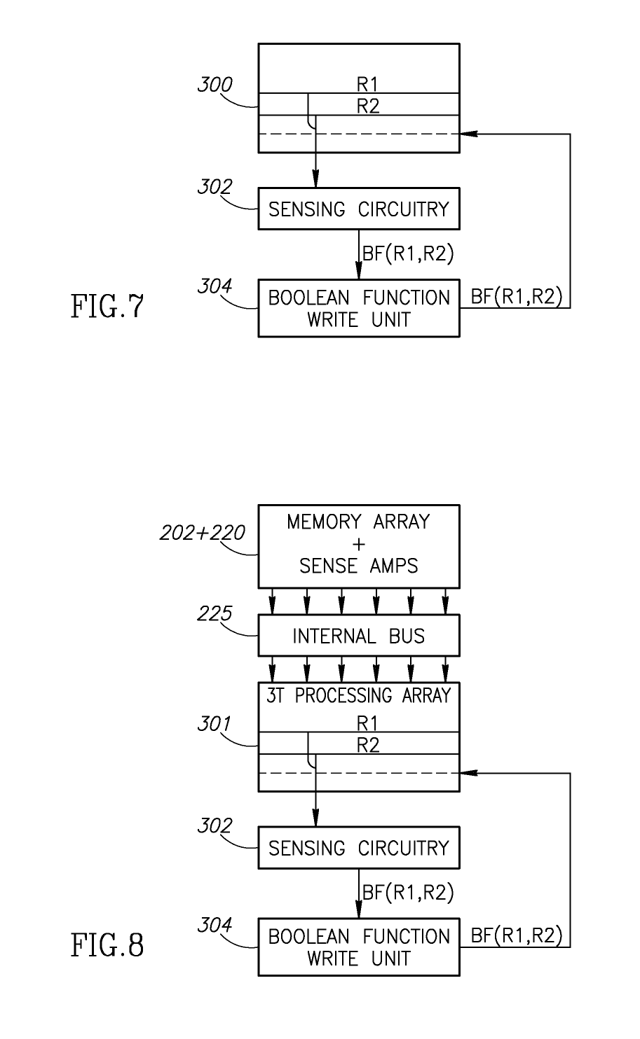

Processing element 224 may be formed of CAM cells or of 3T DRAM cells or any other suitable type of cell. They may perform a calculation or a Boolean operation. The latter is described in U.S. Ser. No. 12/503,916, filed Jul. 16, 2009, owned by the common assignee of the present invention and incorporated herein by reference, and requires relatively few rows in processing element 224. This is discussed hereinbelow with respect to FIGS. 6 and 7.

Processing element 224 may be controlled by compute engine controllers (CEC) 226 which may, in turn, be controlled by microcontroller 228. If microcontroller 228 runs at a lower frequency than the frequency of processing element 224, multiple compute engine controllers 226 may be required.

It may be appreciated that, by placing mirror main sense amplifiers 220 close to processing element 224, there may be a minimum of additional wiring to bring data to processing element 224. Furthermore, by placing all of the internal processing elements (i.e. mirror main sense amplifiers 220, buffers 221, processing element 224, internal bus 225, compute engine controllers 226 and microcontroller 228) within CE belt 214 (rather than in separate computation sections 64 as previously discussed), the present invention may incur a relatively small increase to the real estate of a standard DRAM, while providing a significant increase in its functioning.

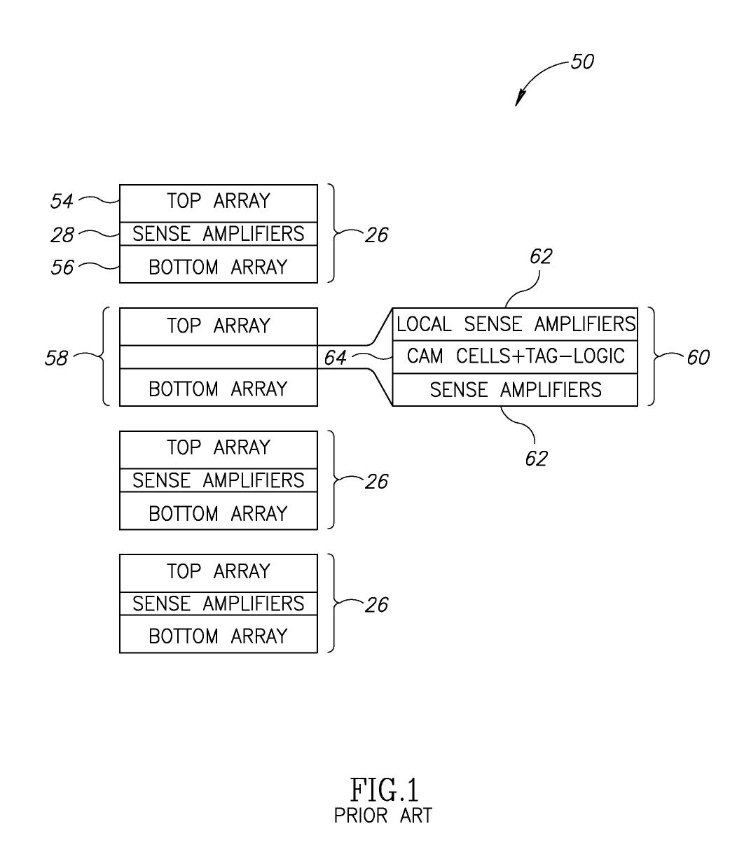

Applicants have realized that the physical disordering of the data from its original, logical form upon storing the data makes the massively parallel processing of computation section 64 (FIG. 1) difficult. However, the architecture of memory device 202 may be useful for reordering the data back to its original, logical order.

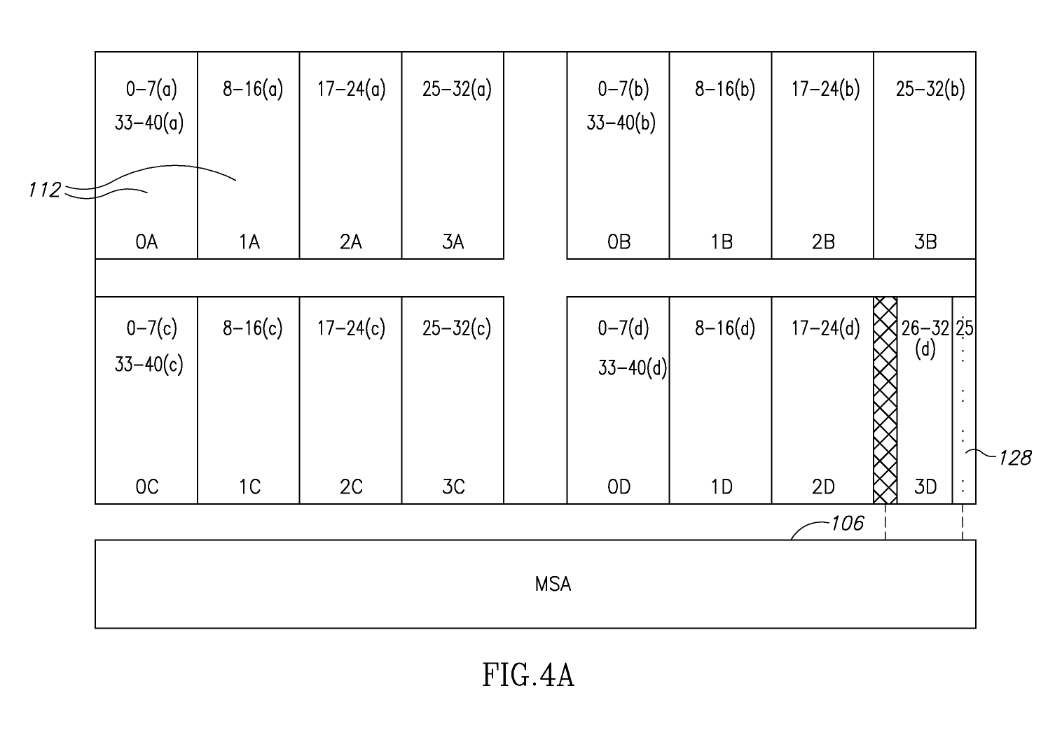

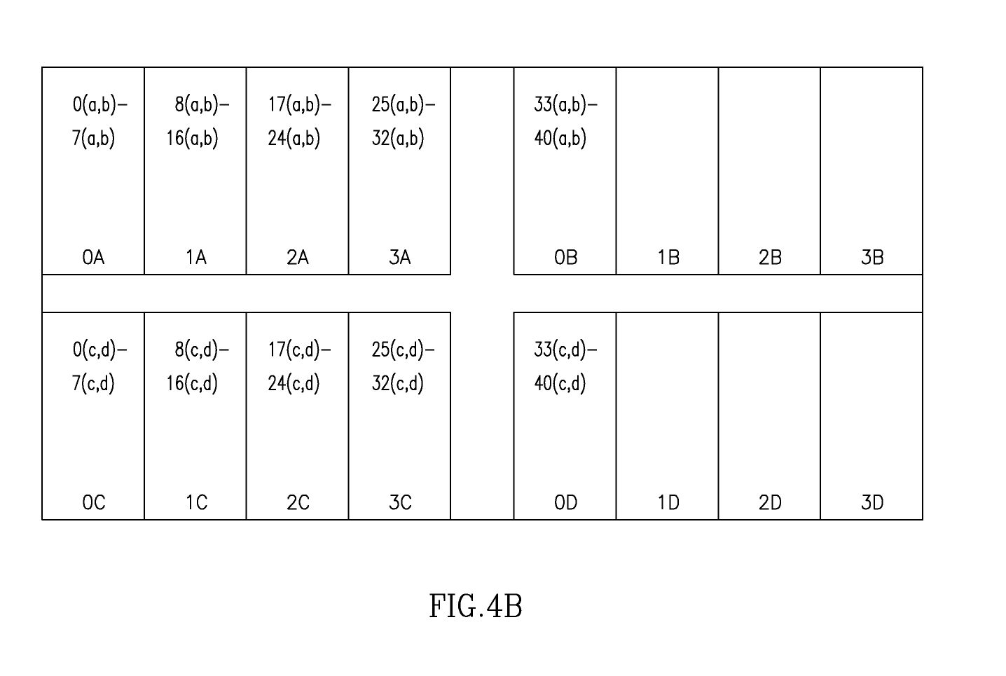

FIGS. 2A, 4A and 4B, to which reference is now made, illustrate an exemplary problem. When external device 10 (FIG. 2A) writes data to DRAM 100 (FIG. 2A), it typically provides the data as a row of words to be written to a specific bank, such as bank 0. The words may be of 16 or 32 bits each. For example, external device 10 may write words 0-7 into bank 0, words 8-16 into bank 1, words 17-24 in bank 2 and words 25-32 into bank 3.

DRAM 100 then stores the data in memory array 102. However, address decoder 104 and the other elements (not shown) involved in writing to memory array 102 allocate neighboring logical addresses such that neighboring logical addresses are not next to each other in the array. Two examples of this are shown in FIGS. 4A and 4B.

Address decoder 104 may divide each 32 bit word into four, 8 bit bytes, labeled “a”, “b”, “c” and “d” and, in the example of FIG. 4A, may store them in the A, B, C and D regions 110, respectively. Thus, if, as an example, each row of each bank can only hold 8 words, as shown in FIG. 4A, then the (a) byte of words 0-7 may be stored in quad0A, the (b) byte may be stored in quad0B, the (c) byte may be stored in quad0C and the (d) byte may be stored in quad0D. Similarly for the other words of the row: the (a) bytes of words 8-16 may be stored in quad1A, the (a) bytes of words 17-24 may be stored in quad2A and the (a) bytes of words 25-32 may be stored in quad 3A. The remaining bytes may be stored in the other quads of the associated banks. Since the first row of each bank is now finished, the (a) bytes of words 33-40 may be stored in the second row of quad0A, or in the second section 120 of quad0A. The example of FIG. 4 shows 8 bytes per row of each quad 112. This is for clarity; typically, 8000 bytes or more may be stored per row.

In an alternative example, shown in FIG. 4B, bank 0 may be divided among quads 0A, 0B, 0C and 0D as in the previous embodiment; however, in this embodiment, each quad may store two bytes of each word. Thus, quad 0A may store the (a) and (b) bytes of the first half of the rows of bank 0, quad 0B may store the (a) and (b) bytes of the second half of the rows, quad 0C may store the (c) and (d) bytes of the first half of the rows and quad 0D may store the (c) and (d) bytes of the second half of the rows. In the simple example of FIG. 4B, quad 0A stores the (a) and (b) bytes of words 0-7, quad 0B stores the (a) and (b) bytes of words 33-40 (the second half of the rows in this example), quad 0C stores the (c) and (d) bytes of words 0-7 and quad 0D stores the (c) and (d) bytes of words 33-40.

Neither situation presents a problem for external access to the data, since external device 10 is not aware of how memory array 102 internally stores the data. Address decoder 104 is responsible for translating the address request of the external element to the actual storage location within memory 102 and the data which is read out is reordered before it arrives back at external device 10.

Address decoder 104 is responsible for another address request translation also illustrated in FIG. 4A. DRAM chips contain a very high density of electronic circuitry as well as an extremely large number of circuits. The manufacturing process always contains a few errors. This means that out of the 2 billion or more memory cells, some are bad. This is solved by adding redundant circuitry. There are extra rows in the quads such that rows containing bad cells are not used. These are replaced by the extra rows. Similarly, columns can be replaced with additional, otherwise redundant, extra columns. For example, in FIG. 4A, quad 3D has a bad column, marked with hashing, where the byte 25(d) was to be stored. Address decoder 104 replaces the bad column by a redundant column 128 of quad 3D, marked with dots, to the right of the quad. Address decoder 104 may comprise a mapper (not shown) to map the data of redundant column 128 to the column it replaces, directing any read or write requests for the bad column to redundant column 128. The result is that the output to main sense amplifiers 106 is in the correct column or row order.

In U.S. patent application Ser. No. 12/119,197, the data is sequential and is copied from one row of memory into a row in computation section 64 (FIG. 1). Computation section 64 then performs parallel processing on the data of the copied row. U.S. patent application Ser. No. 12/119,197 operates best when parallel operations do not require accessing neighboring data. However, for algorithms that require operations between current data and neighboring data, performance levels may be affected by the fact that DRAM 100 rearranges the data from its original, logical order to a different, physical order.

For example, image processing processes images by performing neighborhood operations on pixels in the neighborhood around a central pixel. A typical operation of this sort may be a blurring operation or the finding of an edge of an object in the image. These operations typically utilize direct cosine translations (DCTs), convolutions, etc. In DRAM 100, neighboring pixels may be far away from each other (for example, in FIG. 4A, bit 8 is not in the same quad 112 as bit 7).

Similarly, many parallel processing paradigms, whether of U.S. Ser. No. 12/119,197 or some other paradigm, cannot rely on copying the data out of memory array 102 one row at a time.

In accordance with a preferred embodiment of the present invention, by placing the internal processing elements in computation belt 214, rather than within each computation section 64 (which typically is located within section 120 of quad 112), the mapping operation of address decoder 104, which ensures that main sense amplifiers 106 receive the correct data, irrespective of any bad columns, may be utilized. Thus, mirror main sense amplifiers 220 may also receive the correct data.

Furthermore, in accordance with a preferred embodiment of the present invention, internal bus 225 may be a rearranging bus to compensate for the physical disordering across quads 112, by bringing data from all of the quads 112 to processing element 224. The particular structure of internal bus 225 may be a function of the kind of disordering performed by the DRAM, whether that of FIG. 4A or 4B or some other disordering.

It will be appreciated that internal bus 225 may reorder the data to bring it back to its original, logical, order, such that processing element 224 may perform parallel processing thereon, as described hereinbelow.

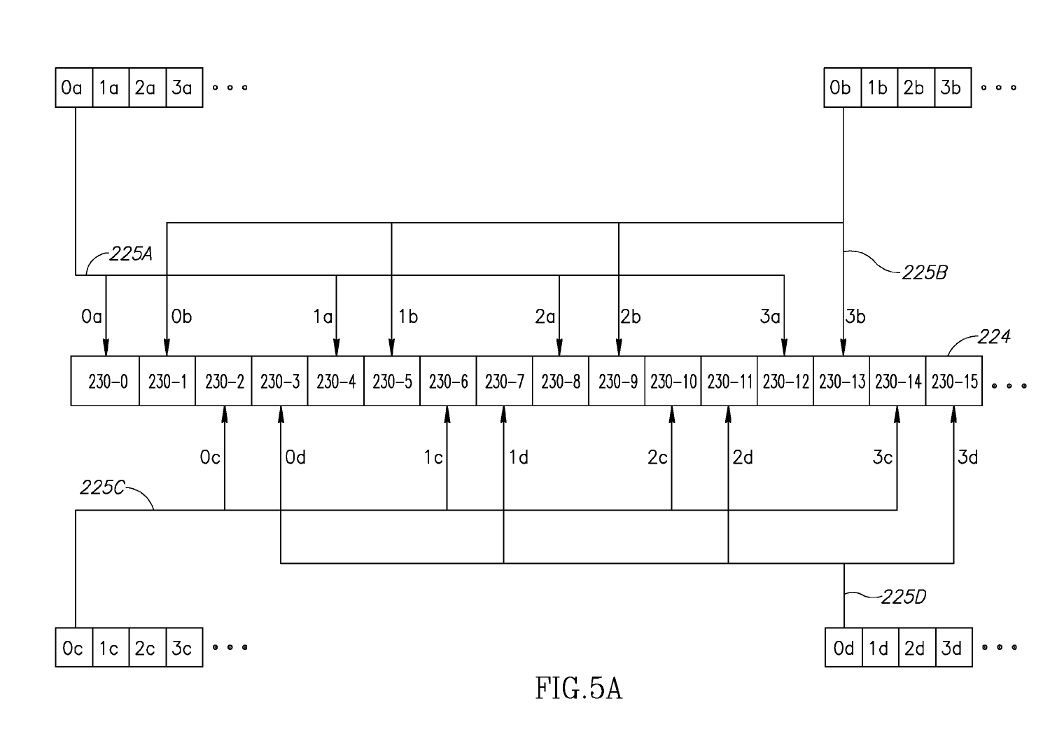

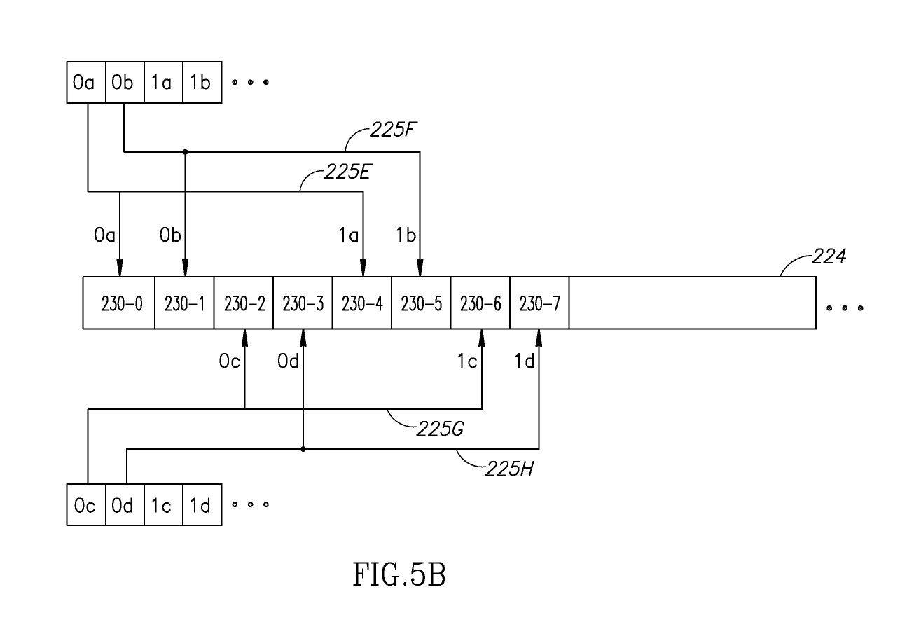

Reference is now made to FIGS. 5A and 5B, which illustrate the structure of internal bus 225 for the physical disordering of FIGS. 4A and 4B, respectively. Internal bus 225 may be a bus connecting the output of mirror main sense amplifiers 220 to processing element 224 and may, under control of compute engine controllers 226, drop the output of mirror main sense amplifiers 220 into the appropriate byte storage unit 230 of processing element 224, thereby to recreate the logical order of the original data, before it was stored in quads 112. This may provide the separate bytes of each word together in processing element 224 and may provide neighboring words in proximity to each other.

MCU 228 may instruct internal bus 225 to bring M bytes of a row from each quad 112 of one bank at each cycle. In the example of FIGS. 4A and 5A, M may be 4 and the MCU 228 may instruct internal bus 225 to provide each byte to every fourth byte storage unit 230-X of processing element 230. In the example of FIG. 5A, line 225A may indicate a first cycle in which internal bus 225 may provide each byte (the (a) byte) from quad 0A to the byte storage units 230-0, 230-4, 230-8 and 230-12. Line 225B may indicate a second cycle in which internal bus 225 may provide the (b) bytes from quad 0B to the byte storage unit 230-X where Xmod4 provides a remainder of 1 (i.e. 1, 5, 9, 13). Line 225C may indicate a third cycle in which internal bus 225 may provide the (c) bytes from quad 0C to the byte storage unit 230-X where Xmod4 provides a remainder of 2 (i.e. 2, 6, 10, 14) and line 225D may indicate a fourth cycle in which internal bus 225 may provide the (d) bytes from quad 0D to the byte storage unit 230-X where Xmod4 provides a remainder of 3 (i.e. 3, 7, 11, 15). In the simplified example of FIG. 5A, four words are brought to 16 byte storage units 230-0-230-15; word 0 is in byte storage units 230-{0-3}, word 1 is in byte storage units 230-{4-7}, word 2 is in byte storage units 230-{8-11} and word 3 is in byte storage units 230-{12-15}.

In the example of FIGS. 4B and 5B, M may be 4 again but MCU 228 may instruct internal bus 225 to provide a pair of neighboring bytes to every other pair of neighboring sections 230-X. To do so, in the example of FIG. 5B, there are two lines from each quad which may operate together in a single cycle. Lines 225E and 225F may indicate a first cycle in which internal bus 225 may provide the (a) and (b) bytes, respectively, of the first two words (0 and 1) from quad 0A. Line 225E may provide the (a) bytes to byte storage units 230-0 and 230-4 while line 225F may provide the (b) bytes to byte storage units 230-1 and 230-5. From the other quad, lines 225G and 225H may indicate a second cycle in which internal bus 225 may provide the (b) and (c) bytes from of the first two words from quad 0C. Line 225G may provide the (c) bytes to the byte storage units 230-2 and 230-6 while line 225H may provide the (d) bytes to byte storage units 230-3 and 230-7.

In this manner, internal bus 225 may bring the separated bytes next to each other in processing element 230. The number of bits read in a cycle may vary. For example, 128 bits may be read each cycle with each read coming entirely from one quad. Alternatively, 64 bits or 128 bits may read from 2 quads in one cycle. It will be understood that internal bus 225 may bring any desired amount of data during a cycle.

Internal bus 225 may bring the data of a single bank to processing element 224, thereby countering the disorder of a single bank. However, this may be insufficient, particularly for performing neighborhood operations on the data at one end or other of a bank (in the example of FIGS. 5A and 5B, an operation requiring word 7 from bank 0 and word 8 from bank 1). To solve this problem, MCU 228 may indicate to internal bus 225 to take some data from one bank followed by some data from its neighboring bank. In particular, MCU 228 may indicate where the first bit of each bank is to be placed. Instead of placing it at the beginning of processing element 224, in byte storage unit 230-0, MCU 228 may indicate to place the first byte in another byte storage unit, such as unit 230-8. Internal bus 225 may then store the remaining bytes in the order discussed hereinabove, after the first byte.

It will be appreciated that processing element 224 may have multiple rows therein and that MCU 228 may indicate to internal bus 225 to place the data in any appropriate row of processing element 224. This may be particularly useful for neighborhood operations and/or for operations performed on multiple rows of data.

In another embodiment, MCU 228 may instruct internal bus 225 to place the data of subsequent cycles to a row of processing element 224 directly below the data from a previous cycle.

It will be appreciated that the combination of internal bus 225 (a hardware element) and MCU 228 with compute engine controllers 226 (under software control) may enable any rearrangement of the data. Thus, if each bank of the DRAM is divided into N storage units (where, in the example shown hereinabove, there were 4 storage units called quads), MCU 228 may instruct internal bus 225 to drop the bytes of each storage unit at every Nth byte storage unit 230 of processing element 224 (for the embodiment of FIG. 5A) or by twos (for the embodiment of FIG. 5B).

In an alternative embodiment, internal bus 225 may bring the data directly to processing element 224, rather than dropping the data every Nth section.

In one embodiment, processing element 224 may comprise storage rows, storing the data as described hereinabove, and processing rows, in which the computations may occur. Any appropriate processing may occur. Processing element 224 may perform the same operation on each row or set of rows, thereby providing a massively parallel processing operation within memory device 202. In another embodiment, memory array 101 is not a DRAM but any other type of memory array, such as SRAM (Static RAM), Flash, ZRAM (Zero-Capacitor RAM), etc. It will be appreciated that the above discussion provided the data to processing element 224. Each of the elements may also operate in reverse. Thus, internal bus 225 may take the data of a row of processing element 224, for example, after processing of the row has finished, and may provide it to mirror main sense amplifiers 220, which, in turn, may write the bytes to the separate quads 112, according to the physical order.

In an alternative embodiment, CE belt 204 may not include mirror main sense amplifiers 220 and may, instead, utilize main sense amplifiers 126.

In a further embodiment, processing element 224 may comprise a shift operator 250, shown in FIG. 6 to which reference is now made. Shift operator 250 may shift a bit to the right or to the left, as is often needed for image processing operations.

As shown in FIG. 6, shift operator 250 may be located between two rows of processing element 224, shown as rows 224-1 and 224-2. Between two cells of rows 224-1 and 224-2 may be one set of left and right shifting passgates 252-1 and 254-1, respectively, to determine the direction of shift, a shift transistor 256 to shift the data 1 location to the right or left and a second set of left and right shifting passgates 252-2 and 254-2, respectively, to complete the operation.

Shift operator 250 may additionally comprise select lines for each set of transistors, a “shift_left” to control both sets 252-1 and 252-2, a “shift right” to control both sets 254-1 and 254-2, and a “shift_{—}1” to control set 256.

To shift a row of data elements to the right, for example, to shift data elements from location A1 to location A2, location A2 to location A3, etc., CEC 226 may activate select lines shift right, to activate both sets of right direction gates 254-1 and 254-2, and shift_{—}1 to shift the data by one data element. The exemplary path is marked in FIG. 6, from element A1 in row 224-2, to its nearby right direction gate 254-2 to shift transistor 256 to right direction gate 254-1 to element A1.

If desired, shift operator 250 may also include other shift transistors between the sets of direction shifting gates 252 and 254, to shift the data more than one location to the right or to the left. These shift transistors may be selectable, such that shift operator 250 may be activated to shift by a different amount of data elements each time it is activated.

It will be appreciated that shift operator 250 also includes a direct path 258 from each element (e.g. A1) of row 224-1 to its corresponding element (e.g. A1) of row 224-2, for operations which do not require a shift.

It will be appreciated that shift operator 250 may provide a parallel shift operation, since it operates on an entire row at once.

Reference is now briefly made to FIGS. 7 and 8. FIG. 7 illustrates the in-memory processing described in U.S. Ser. No. 12/503,916 and FIG. 8 illustrates such processing for memory device 202. FIG. 7 shows a 3T memory array 300, sensing circuitry 302 and a Boolean function write unit 304. As discussed in U.S. Ser. No. 12/503,916, due to the nature of 3T DRAM cells, sensing circuitry 302 will sense a NOR of the activated cells in each column. Thus, sensing circuitry 302 senses a Boolean function BF of rows R1 and R2. Since the Boolean operation is performed during the sensing operation, all Boolean function write unit 304 has to do is write the result back into a selected row of memory array 300.

In the embodiment of FIG. 8, the in-memory processing of FIG. 7 is implemented for processing element 224. For clarity, memory device 202 and mirror main sense amplifiers 220 are shown together as a single box and their output is provided to internal bus 225. In this embodiment, processing element 224 is replaced with a 3T memory array, here labeled 301, sensing circuitry 302 and Boolean function write unit 304. In operation, internal bus 225 may reorder the data of memory device 202, placing it into the appropriate row of 3T array 301. Compute engine controllers 226 (not shown in FIG. 8) may then activate various rows of 3T array 301 for processing. Sensing circuitry 302 may sense the result, which may be a Boolean function of the activated rows, and write unit 304 may write the result back into 3T array 301. At some later point, when processing has finished, internal bus 225 may write the data back to memory device 202, as per its physical arrangement.

Memory device 202 may also be formed from a 3T DRAM memory array. In this embodiment, the memory array may have two sections, one storing the physically disordered data, and one for in-memory processing. Internal bus 225 may take the disordered data, reorder it and rewrite it back to the in-memory processing section.

In an alternative embodiment, the memory array may have only one section. The data may initially be written into it in a disordered way. Whenever a row or a section of data may be desired to be processed, the row may be read out, reordered by internal bus 225 and then written back, in order, into the row or section. Memory device 202 may then process the reordered data, in place, as discussed in U.S. Ser. No. 12/503,916.

It will be appreciated that the present invention may provide in-memory parallel processing for any memory array which may have a different physical order for storage than the original, logical order of the data. The present invention provides decoding, by reading with mirror main sense amplifiers 220, rearranging, via internal bus 225, and configuration, via compute engine controllers 226, to control where bus 225 places the data in processing element 224. This simple mechanism may restore any disordering of the data and thus, may enable parallel processing, particularly for performing neighborhood operations.

As discussed hereinabove, some of the neighborhood operations may include shift operations. Thus, memory device 202 may be able to perform a logical or mathematical computation on neighborhood data in its logical order after which the results may be shifted to the right or left and the shifted result returned for storage in its physical order.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A memory device comprising:
an external device interface connectable to an external device communicating with said memory device;
an internal processing element to process data stored on said device; and
multiple banks of storage, wherein each bank comprises a plurality of storage units and each storage unit having two ports, an external port connectable to said external device interface and an internal port connected to said internal processing element.

2. The memory device according to claim 1 wherein said plurality of storage units are formed into an upper row of units and a lower row of units and also comprising a computation belt between said upper and lower rows, wherein said internal port and said processing element are located within said computation belt.

3. The memory device according to claim 2 and wherein said computation belt comprises an internal bus to transfer said data from said internal port to said processing element.

4. The memory device according to claim 3 wherein said internal bus is a reordering bus to reorder the output of said internal port to match a pre-storage logical order of said data.

5. The memory device according to claim 4 and wherein said reordering bus comprises four lines each to provide bytes from one of said internal ports to every fourth byte storage unit of said processing element.

6. The memory device according to claim 5 and wherein each said line connects between one internal port and said processing element.

7. The memory device according to claim 5 and wherein two of said lines connect between one internal port and said processing element.

8. The memory device according to claim 3 wherein said internal port comprises a plurality of sense amplifiers and a buffer to store the output of said sense amplifiers.

9. The memory device according to claim 1 and wherein said banks of storage comprise one of the following types of memory: DRAM memory, 3T DRAM, SRAM memory, ZRAM memory and Flash memory.

10. The memory device according to claim 1 and wherein said processing element comprises 3T DRAM elements.

11. The memory device according to claim 10 wherein said processing element also comprises sensing circuitry to sense a boolean function of at least two activated rows of said 3T DRAM elements.

12. The memory device according to claim 1 and wherein said processing element comprises a shift operator.

13. A memory device comprising:
a plurality of storage banks in which to store data formed into an upper row of units and a lower row of units; and
a computation belt between said upper and lower rows to perform on-chip processing of data from said storage units.

14. The memory device according to claim 13 wherein each said bank comprises a plurality of storage units and each storage unit has an internal port forming part of said computation belt.

15. The memory device according to claim 14 and wherein said computation belt additionally comprises a processing element.

16. The memory device according to claim 15 and wherein said computation belt comprises an internal bus to transfer said data from said internal ports to said processing element.

17. The memory device according to claim 16 wherein said internal bus is a reordering bus to reorder the output of said internal port to match a pre-storage logical order of said data.

18. The memory device according to claim 17 and wherein said reordering bus comprises four lines each to provide bytes from one of said internal ports to every fourth byte storage unit of said processing element.

19. The memory device according to claim 18 and wherein each said line connects between one internal port and said processing element.

20. The memory device according to claim 18 and wherein two of said lines connect between one internal port and said processing element.

21. The memory device according to claim 16 wherein said internal port comprises a plurality of sense amplifiers and a buffer to store the output of said sense amplifiers.

22. The memory device according to claim 13 and wherein said banks comprise one of the following types of memory: DRAM memory, 3T DRAM, SRAM memory, ZRAM memory and Flash memory.

23. The memory device according to claim 15 and wherein said processing element comprises 3T DRAM elements.

24. The memory device according to claim 23 wherein said processing element also comprises sensing circuitry to sense a boolean function of at least two activated rows of said 3T DRAM elements.

25. The memory device according to claim 15 and wherein said processing element comprises a shift operator.

26. A memory device comprising:
a plurality of storage units in which to store data of a bank, wherein said data has a logical order prior to storage and a physical order different than said logical order within said plurality of storage units; and
a within-device reordering unit to reorder said data of a bank into said logical order prior to performing on-chip processing.

27. The memory device according to claim 26 and wherein said storage units are formed of DRAM memory units.

28. The memory device according to claim 26 wherein said reordering unit comprises:
a plurality of sense amplifiers, each to read data of its associated storage unit; and
a data transfer unit to reorder the output of said sense amplifiers to match said logical order of said data.

29. The memory device according to claim 28 wherein N storage units spread across said memory device form a bank to which an external device writes data and wherein said data transfer unit operates to provide data of one bank to an on-chip processing element.

30. The memory device according to claim 29 wherein said data transfer unit comprises an internal bus and at least one compute engine controller at least to indicate to said internal bus how to place data from each of said plurality of said sense amplifiers associated with storage units of one of said banks into said processing element.

31. The memory device according to claim 30 and wherein said internal bus comprises N lines each to transfer a unit of data between said sense amplifiers of one storage unit and every Nth data location of said processing element, wherein said lines together connect to all data locations of said processing element.

32. The memory device according to claim 30 and wherein said internal bus comprises N lines each to transfer a unit of data between said sense amplifiers and every Nth data location of said processing element, wherein two of said lines transfer from one storage unit and two of said lines transfer from a second storage unit.

33. The memory device according to claim 30 wherein said at least one compute engine controller indicates to said internal bus where to begin placement or removal of said data.

34. The memory device according to claim 29 and wherein said processing element comprises a 3T DRAM array, sensing circuitry for sensing the output when multiple rows of said 3T DRAM array are generally simultaneously activated and a write unit to write said output back to said 3T DRAM array.

35. The memory device according to claim 27 and wherein said memory device comprises a 3T DRAM array and said reordering unit writes back to said 3T DRAM array for processing.

36. The memory device according to claim 29 and wherein said processing element comprises a shift operator.

37. The memory device according to claim 34 and wherein said processing element comprises a shift operator.

38. A method of performing parallel processing on a memory device, the method comprising:
on said device, performing neighborhood operations on data stored in a plurality of storage units of a bank, even though said data has a logical order prior to storage and a physical order different than said logical order within said plurality of storage units.

39. The method according to claim 38 and wherein said performing comprises:
accessing data from said plurality of storage units;
reordering said data into its logical order; and
performing neighborhood operations on said reordered data.

40. The method according to claim 38 and wherein said neighborhood operations form part of image processing operations.
